(19) United States
(12) Patent Application Publication
(10) Pub. No.: US 2026/0167201 A1
(43) Pub. Date: Jun. 18, 2026

(54) VEHICLE

(71) Applicant: Toyota Jidosha Kabushiki Kaisha, Toyota-shi (JP)

(72) Inventors: Yoshito SEKIGUCHI, Kariya-shi (JP); Yuki Katayama, Toyota-shi (JP)

(73) Assignee: Toyota Jidosha Kabushiki Kaisha, Toyota-shi (JP)

(21) Appl. No.: 19/404,356

(22) Filed: Dec. 1, 2025

(30) Foreign Application Priority Data
Dec. 16, 2024 (JP) 2024-220159

(51) Int. Cl. B60W 30/188; B60W 30/18; B60W 30/192

(52) U.S. Cl. CPC B60W 30/1886; B60W 30/18054; B60W 30/192; B60W 2510/244; B60W 2710/09; B60W 2710/305

(57) ABSTRACT

The vehicle includes a drive unit that houses a lubrication requiring element in a case, an electric oil pump that sucks oil in the case and supplies oil to the lubrication requiring element, and a control device that controls an operation of the electric oil pump. The control device is configured to execute a preliminary lubrication process for operating the electric oil pump when a predetermined condition is satisfied in a state in which the vehicle is stopped, and a notification process for outputting predetermined notification information to at least one of a user interface of the vehicle and an information terminal owned by the occupant when the preliminary lubrication process is executed.

### CROSS-REFERENCE TO RELATED APPLICATION

This application claims priority to Japanese Patent Application No. 2024-220159 filed on Dec. 16, 2024. The disclosure of the above-identified application, including the specification, drawings, and claims, is incorporated by reference herein in its entirety.

### BACKGROUND

### 1. Technical Field

The technique disclosed in the present specification relates to a vehicle.

### 2. Description of Related Art

Japanese Unexamined Patent Application Publication No. 2024-025399 (JP 2024-025399 A) discloses a vehicle including a drive unit in which a lubrication requiring element is accommodated in a case, an electric oil pump that sucks oil in the case and supplies the oil to the lubrication requiring element, and a control device that controls operation of the electric oil pump. The control device operates the electric oil pump in a state in which the vehicle is stopped.

### SUMMARY

In the vehicle according to JP 2024-025399 A, the electric oil pump is operated in a state in which the vehicle is stopped. In a situation in which the vehicle is stopped, it is easy for an occupant to sense the operating noise of the electric oil pump. When the generation source of a sound sensed by the occupant is unknown, the occupant feels uncomfortable.

The present specification provides a technique capable of suppressing an occupant feeling uncomfortable.

A first aspect disclosed herein discloses a vehicle. The vehicle may include:
a drive unit in which a lubrication requiring element is accommodated in a case;
an electric oil pump that sucks oil in the case and supplies the oil to the lubrication requiring element; and
a control device that controls operation of the electric oil pump.

The control device may be configured to execute
a preliminary lubrication process of operating the electric oil pump when a predetermined condition is satisfied in a state in which the vehicle is stopped, and
an informing process of outputting predetermined notification information to at least one of a user interface of the vehicle and an information terminal owned by an occupant when the preliminary lubrication process is executed.

According to the above configuration, when the preliminary lubrication process is executed, the predetermined notification information is output to the user interface of the vehicle or the information terminal owned by the occupant. The occupant can be informed of the generation source of the sound sensed by the occupant by confirming the predetermined notification information. Thus, it is possible to suppress the occupant feeling uncomfortable.

In a second aspect, in the first aspect, the control device may be configured to suppress execution of the preliminary lubrication process until the state in which the vehicle is stopped stands for more than a predetermined time.

In general, in a state in which the vehicle is stopped, the operation of the electric oil pump is stopped. After the vehicle is stopped, the oil supplied to the lubrication requiring element inside the case during travel gradually accumulates in the lower portion of the case. When the vehicle is stopped for a long time, the amount of oil accumulated in the lower portion of the case increases, and the oil level in the case increases. In this case, the stirring resistance of the components in the case increases. By the preliminary lubrication process, the oil level in the case can be lowered, and as a result, the stirring resistance of the components in the case can be reduced. On the other hand, when the vehicle is stopped for a relatively short time, the oil level in the case is low. Therefore, the stirring resistance of the components in the case is small. In this case, the need to execute the preliminary lubrication process is low. According to the above configuration, the control device suppresses the execution of the preliminary lubrication process until the state in which the vehicle is stopped stands for more than a predetermined time. Thus, it is possible to suppress unnecessary execution of the preliminary lubrication process.

In a third aspect, in the first or second aspect, the predetermined condition may be satisfied when the vehicle is switched from ready-off to ready-on.

When the vehicle is switched from ready-off to ready-on, it is highly likely that the vehicle has been stopped for a long time. Thus, the preliminary lubrication process can be executed at an appropriate timing.

In a fourth aspect, in any one of the first to third aspects, the vehicle may further include a battery that supplies electric power to the electric oil pump. The control device may be configured to suppress execution of the preliminary lubrication process when a remaining amount of the battery is equal to or less than a predetermined value.

The battery also supplies electric power to devices other than the electric oil pump. According to the above configuration, it is possible to suppress shortage of electric power supplied to devices other than the electric oil pump due to operation of the electric oil pump.

In a fifth aspect, in the fourth aspect, the control device may be configured to limit an output of the drive unit when the execution of the preliminary lubrication process is suppressed on condition that the remaining amount of the battery is equal to or less than the predetermined value.

When the remaining amount of the battery is equal to or less than the predetermined value, the amount of oil supplied to the drive unit may become insufficient. According to the above configuration, it is possible to suppress the amount of oil supplied to the drive unit becoming insufficient.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a vehicle 2;

FIG. 2 is a skeleton diagram of a front drive unit 12A mounted on vehicles 2; and

FIG. 3 is a flowchart of an electric oil pump process executed by the control device 18.

### DETAILED DESCRIPTION OF EMBODIMENTS

### First Embodiment

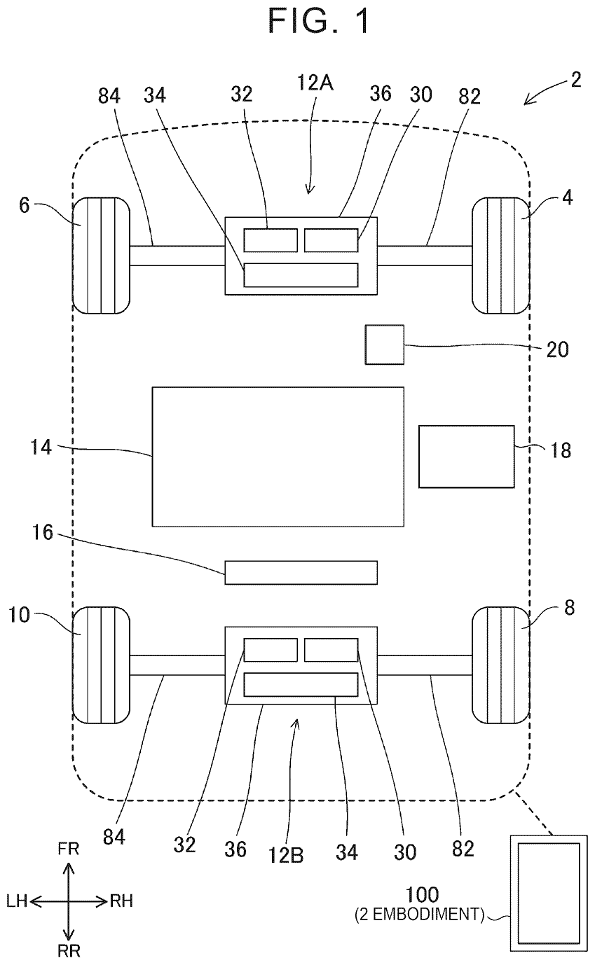

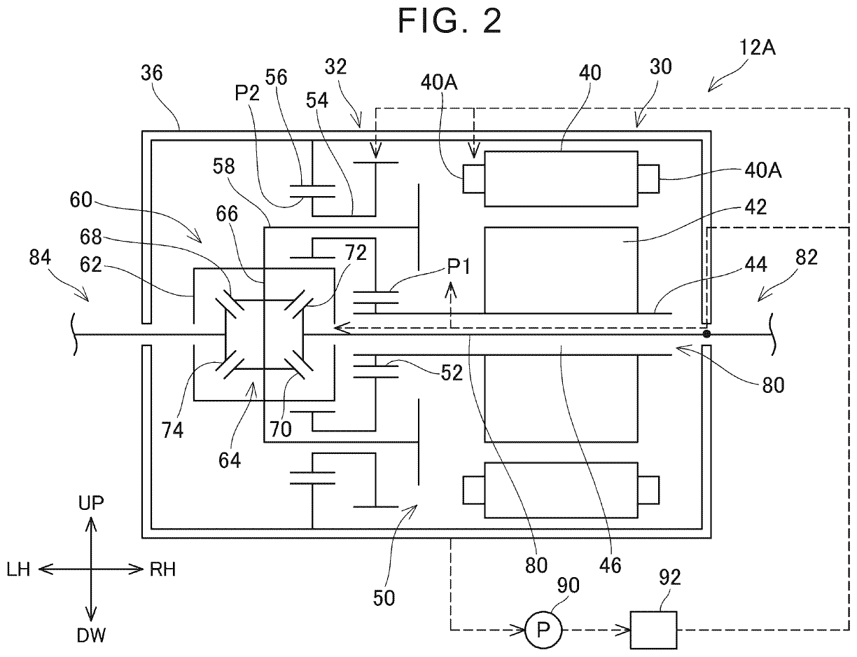

The vehicle 2 will be described with reference to FIGS. 1 and 2. The vehicles 2 are electrified vehicle driven by a rotary electric machine 30 described later. The vehicle 2 may be a hybrid electric vehicle or a fuel-powered vehicle. Here, the directions in FIG. 1 and FIG. 2 correspond to the directions of the vehicle 2. The direction FR in FIG. 1 indicates the front in the front-rear direction of the vehicle 2, and the direction RR in FIG. 1 indicates the rear in the front-rear direction of the vehicle 2. In addition, the direction LH in FIG. 1 and FIG. 2 indicates the left in the left-right direction of the vehicle 2, and the direction RH in FIG. 1 and FIG. 2 indicates the right in the left-right direction of the vehicle 2. The direction UP in FIG. 2 indicates an upper portion in the up-down direction of the vehicle 2, and the direction DW in FIG. 2 indicates a lower portion in the up-down direction of the vehicle 2.

As illustrated in FIG. 1, the vehicle 2 includes a right front wheel 4, a left front wheel 6, a right rear wheel 8, a left rear wheel 10, a front drive unit 12A, a rear drive unit 12B, a main battery 14, an auxiliary battery 16, a control device 18, and a user interface 20. In the present embodiment, the instrument panel is the user interface 20. In the modified example, the user interface 20 may be a speaker.

The front drive unit 12A drives the right front wheel 4 and the left front wheel 6, and the rear drive unit 12B drives the right rear wheel 8 and the left rear wheel 10. The vehicle 2 is exemplified as a four-wheel drive vehicle. In a modification, the vehicle 2 may be a two-wheel drive vehicle in which only one of the front drive unit 12A and the rear drive unit 12B is mounted. The rear drive unit 12B has the same configuration as the front drive unit 12A except for driving the right rear wheel 8 and the left rear wheel 10. Hereinafter, the front drive unit 12A will be described, and the description of the rear drive unit 12B will be omitted.

The front drive unit 12A includes a rotary electric machine 30, a transmission device 32, a power control unit 34, and a case 36. The rotary electric machine 30, the transmission device 32, and the power control unit 34 are housed in a case 36. The power control unit 34 is disposed at a position adjacent to the rotary electric machine 30 and the transmission device 32 on the rear side. The power control unit 34 converts the electric power supplied from the main battery 14 from direct current to alternating current and supplies the converted electric power to the rotary electric machine 30. The rotary electric machine 30 generates a driving force based on the AC power supplied from the power control unit 34. The transmission device 32 distributes the driving force generated by the rotary electric machine 30 to the right front wheel 4 and the left front wheel 6 after the torque is amplified.

Referring to FIG. 2, the rotary electric machine 30 and the transmission device 32 accommodated in the case 36 will be described.

The rotary electric machine 30 includes a stator core 40, a rotor 42, and an output shaft 44. The stator core 40 is fixed to the case 36. A coil end 40A is provided at a right end portion and a left end portion of the stator core 40. The rotor 42 is supported by the case 36 so as to be rotatable about the rotation axis of the rotary electric machine 30. In the present embodiment, the rotation shaft extends along the left-right direction. The output shaft 44 is coupled to the rotor 42 and rotates integrally with the rotor 42. The output shaft 44 is hollow and has a through hole 46 extending along the rotation axis direction of the rotary electric machine 30.

The transmission device 32 includes a planetary gear portion 50 and a differential gear 60. The planetary gear portion 50 decelerates the rotation of the output shaft 44 of the rotary electric machine 30. The differential gear 60 distributes the driving force of the rotary electric machine 30 transmitted through the planetary gear portion 50 to the right front wheel 4 and the left front wheel 6 (see FIG. 1). The rotary electric machine 30, the planetary gear portion 50, and the differential gear 60 are arranged coaxially. Note that the configuration of the transmission device 32 described below is an example, and other types of configurations can be adopted as appropriate.

The planetary gear portion 50 includes a sun gear 52, a plurality of stepped pinion gears 54, a ring gear 56, and a carrier 58. The sun gear 52 is connected to the output shaft 44 of the rotary electric machine 30 and rotates integrally with the output shaft 44. Each of the plurality of stepped pinion gears 54 has a large-diameter pinion gear P1 and a small-diameter pinion gear P2 having a diameter smaller than that of the large-diameter pinion gear P1. The large-diameter pinion gear P1 meshes with the sun gear 52. The small-diameter pinion gear P2 meshes with the ring gear 56. The ring gear 56 is fixed to the case 36. The carrier 58 rotatably supports each of the plurality of stepped pinion gears 54. Thus, in the planetary gear portion 50, the sun gear 52 is an input element, the ring gear 56 is a reaction force element, and the carrier 58 is an output element.

The differential gear 60 includes a differential case 62 and a differential gear mechanism 64. The differential case 62 is supported by the case 36 so as to be rotatable about the rotation axis of the rotary electric machine 30. The differential case 62 is coupled to the carrier 58 of the planetary gear portion 50 and rotates integrally with the carrier 58. The differential gear mechanism 64 is housed in the differential case 62.

The differential gear mechanism 64 includes a pinion shaft 66, a pair of differential pinion gears 68 and 70, a right side gear 72, and a left side gear 74.

The pinion shaft 66 is connected to the differential case 62 and rotates integrally with the differential case 62. The pinion shaft 66 extends in the differential case 62 along a direction orthogonal to the rotation axis direction of the rotary electric machine 30. Each of the pair of differential pinion gears 68 and 70 is supported by the pinion shaft 66 so as to be rotatable about the axis of the pinion shaft 66. The right side gear 72 is a member that outputs a driving force to the right front wheel 4 and meshes with each of the pair of differential pinion gears 68 and 70. The left side gear 74 is a member that outputs a driving force to the left front wheel 6 and meshes with each of the pair of differential pinion gears 68 and 70.

The front drive unit 12A further includes an intermediate shaft 80, a right drive shaft 82 coupled to the right front wheel 4 (see FIG. 1), and a left drive shaft 84 coupled to the left front wheel 6 (see FIG. 1).

The intermediate shaft 80 extends in the through hole 46 of the output shaft 44 along the rotation axis direction of the rotary electric machine 30. The left end of the intermediate shaft 80 is connected to the right side gear 72 of the differential gear 60, and the right end of the intermediate shaft 80 is connected to the right drive shaft 82. That is, the intermediate shaft 80 transmits the torque of the rotary electric machine 30 transmitted through the output shaft 44, the planetary gear portion 50, and the differential gear mechanism 64 to the right front wheel 4.

A right end portion of the left drive shaft 84 is connected to the left side gear 74. The driving force output from the left side gear 74 is directly transmitted to the left drive shaft 84.

The vehicle 2 includes an electric oil pump 90 and an oil cooler 92. In FIG. 2, the flow of oil is indicated by a broken line. The oil cooler 92 cools the oil. When the electric oil pump 90 is operated, the oil in the case 36 is sucked. Specifically, the electric oil pump 90 sucks the oil staying in the lower portion of the case 36. The oil sucked by the electric oil pump 90 passes through the oil cooler 92 and is discharged toward the lubrication requiring element and the cooling requiring element in the case 36. The rotary electric machine 30 and the transmission device 32 are examples of the lubrication requiring element and the cooling requiring element.

An example of the position where the oil is discharged will be described. The oil is discharged from above the case 36 toward the coil end 40A of the stator core 40. Further, the oil is discharged from the upper portion of the case 36 toward the transmission device 32. Further, the oil passes through the through hole 46 along the rotation axis direction of the output shaft 44 and the through hole on the outer peripheral surface of the output shaft 44, and is discharged into the case 36. Further, the oil is discharged toward the differential gear 60 through the through hole in the rotation axis direction in the intermediate shaft 80.

The main battery 14 in FIG. 1 is a battery that supplies power to the power control unit 34. The main battery 14 is a secondary battery in which a plurality of battery cells is connected in series. As an example, the main battery 14 is disposed below the floor panel of the vehicle 2.

The auxiliary battery 16 is a battery that supplies the auxiliary machine. The auxiliary equipment includes an electric oil pump 90, an oil cooler 92, lights, audio equipment, a car navigation system, a drive recorder, and the like. The auxiliary battery 16 is a secondary battery in which a plurality of battery cells is connected in series. The rated voltage of the auxiliary battery 16 is lower than the rated voltage of the main battery 14. In an exemplary embodiment, the rated voltage of the auxiliary battery 16 is 12 V, and the rated voltage of the main battery 14 is 200 V to 600 V. As an example, the auxiliary battery 16 is disposed below the luggage room of the rear compartment of the vehicle 2.

The control device 18 is configured as a computer including a processor and memories such as a RAM and a ROM. The control device 18 controls the operation of each unit of the vehicle 2 in accordance with a program stored in a ROM or the like.

The control device 18 is configured to be able to selectively execute the normal traveling mode and the restricted traveling mode. The limited travel mode is a mode in which the power of the front drive unit 12A and the power of the rear drive unit 12B are limited as compared with the normal travel mode.

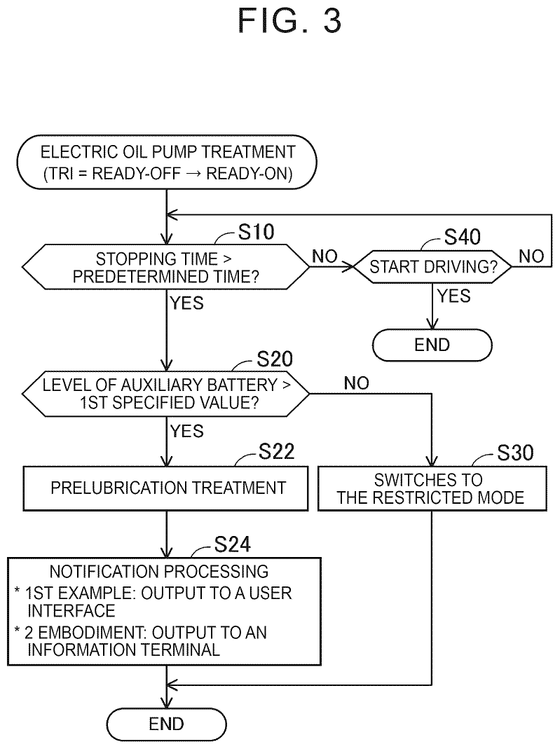

### Electric Oil Pump Treatment; FIG. 3

An electric oil pump process executed by the control device 18 of the vehicle 2 will be described with reference to FIG. 3. The control device 18 starts the process of FIG. 3 when the vehicle 2 is switched from the ready-off state (Ready-OFF) to the ready-on state (Ready-ON). Here, the ready-off is a state in which the power of the vehicle 2 is turned off. The ready-on state indicates a state in which the power of the vehicle 2 is turned on, and indicates a state in which the rotary electric machine 30 and the power control unit 34 can be driven. Note that the electric oil pump 90 is stopped at the time when FIG. 3 starts.

In S10, the control device 18 determines whether or not the time during which the vehicles 2 are stopped exceeds a predetermined time. Hereinafter, the time during which the vehicle 2 is stopped is referred to as a “stop time”. When the stopping time exceeds the predetermined time (YES in S10), the control device 18 proceeds to S20. On the other hand, when the stopping time does not exceed the predetermined time (NO in S10), the control device 18 proceeds to S40. In the present embodiment, the predetermined time is constant. In the modified example, the predetermined time may be changed in accordance with the outside air temperature, the previous traveling time, and the like. As an example, the predetermined time may be shortened as the previous operation time is shorter. Further, as an example, the predetermined time may be increased as the outside air temperature is lower.

In S40, the control device 18 determines whether or not the vehicle 2 has started traveling. Specifically, the control device 18 determines whether or not the state of the vehicle 2 has been switched from the stop state to the running state. When the state of the vehicle 2 is switched from the stopped state to the traveling state (YES in S40), the control device 18 ends the process of FIG. 3. On the other hand, when the state of the vehicle 2 is not switched from the stopped state to the traveling state (NO in S40), the control device 18 returns to S10.

In S20, the control device 18 determines whether or not the remaining capacity of the auxiliary battery 16 exceeds the first predetermined value. When the remaining capacity of the auxiliary battery 16 exceeds the first predetermined value (YES in S20), the control device 18 proceeds to S22. On the other hand, when the remaining amount of the auxiliary battery 16 does not exceed the first predetermined value, that is, when the remaining amount of the auxiliary battery 16 is equal to or less than the first predetermined value (NO in S20), the control device 18 proceeds to S30.

In S22, the control device 18 executes a preliminary lubrication process for operating the electric oil pump 90. As a result, the oil accumulated in the lower portion of the case 36 is sucked, and the oil is supplied into the case 36. Therefore, the oil level in the case 36 can be lowered, and the oil can be supplied to the lubrication requiring element in the case 36.

In S24, the control device 18 executes a notification process of outputting predetermined notification information to the user interface 20 of the vehicle 2. The predetermined notification information is information indicating that the preliminary lubrication process is being executed. When S24 ends, the control device 18 ends the process of FIG. 3.

In addition, in S30, the control device 18 shifts from the normal traveling mode to the restricted traveling mode. That is, when the remaining amount of the auxiliary battery 16 is equal to or less than the first predetermined value, the control device 18 does not execute the preliminary lubrication process for operating the electric oil pump 90. When S30 ends, the control device 18 ends the process of FIG. 3. When the remaining amount of the auxiliary battery 16 exceeds the second predetermined value during traveling or the like, the control device 18 shifts from the limited traveling mode to the normal traveling mode. The second predetermined value may be the same as or larger than the first predetermined value.

As described above, a predetermined condition is satisfied in which the vehicle 2 is switched from ready-off to ready-on, the stopping time exceeds a predetermined time (YES in S10), and the remaining amount of the auxiliary battery 16 exceeds a first predetermined value (YES in S20). Here, the control device 18 executes a preliminary lubricating process (S22) and a notification process (S24).

### Effect of This Example

As described above, the vehicle 2 includes a front drive unit 12A (an exemplary “drive unit”) that houses a lubrication requiring element in the case 36, an electric oil pump 90, and a control device 18 that controls the operation of the electric oil pump 90. The electric oil pump 90 sucks the oil in the case 36 and supplies the oil to the lubrication requiring element. The control device 18 is configured to be capable of executing a preliminary lubricating process (S22) and a notification process (S24) when a predetermined condition is satisfied while the vehicle 2 is stopped.

According to the above configuration, when the preliminary lubrication process is executed, predetermined notification information is displayed (output) on the instrument panel of the vehicle 2. The occupant can know the generation source of the sound sensed by the occupant by confirming the predetermined notification information. Therefore, it is possible to suppress the occupant feeling uncomfortable.

In addition, when the electric oil pump 90 is operated, the oil level in the case 36 can be lowered while the vehicle is stopped, and the oil can be supplied to the components in the front drive unit 12A.

Further, the control device 18 is configured to suppress executing the preliminary lubrication process until the vehicle 2 is stopped for more than a predetermined period (NO in S10 of FIG. 3).

Generally, in a state in which the vehicle 2 is stopped, the operation of the electric oil pump 90 is stopped. After the vehicle 2 is stopped, the oil supplied to the lubrication requiring element inside the case 36 gradually accumulates in the lower portion of the case 36 during traveling. When the time during which the vehicle 2 is stopped becomes long, the amount of oil accumulated in the lower portion of the case 36 increases, and the oil level in the case 36 increases. In this case, the stirring resistance of the components in the case 36 increases. When the preliminary lubrication process is executed, the oil level in the case 36 can be lowered. Therefore, the stirring resistance of the components in the case 36 can be reduced. On the other hand, when the time during which the vehicle 2 is stopped is relatively short, the oil level in the case 36 is low. Therefore, the stirring resistance of the components in the case 36 is small. In this case, the need to perform a preliminary lubrication process is low. According to the above configuration, the control device 18 suppresses the execution of the preliminary lubrication process until the state in which the vehicle 2 is stopped exceeds a predetermined time. Therefore, it is possible to suppress the preliminary lubrication process being unnecessarily executed in a state in which the vehicle 2 is stopped.

In addition, when the vehicle 2 is switched from ready-off to ready-on, a predetermined condition is established.

When the vehicle 2 is switched from the ready-off state to the ready-on state, it is highly likely that the vehicle 2 has been stopped for a long time. Therefore, the preliminary lubrication process can be executed at an appropriate timing.

The vehicle 2 further includes an auxiliary battery 16 (an example of a “battery”) that supplies electric power to the electric oil pump 90. The control device 18 is configured to suppress executing the preliminary lubrication process when the remaining battery level is equal to or less than the first predetermined value (an example of the “predetermined value”) (NO in S20).

The auxiliary battery 16 also supplies electric power to devices other than the electric oil pump 90. According to the above configuration, it is possible to suppress shortage of electric power supplied to devices other than the electric oil pump 90 due to the operation of the electric oil pump 90.

Further, the control device 18 is configured to restrict the output of the front drive unit 12A when the execution of the preliminary lubrication process is suppressed (NO in S20) on condition that the remaining amount of the auxiliary battery 16 is equal to or less than the first predetermined value (S30).

When the remaining amount of the auxiliary battery 16 is equal to or less than the first predetermined value, the amount of oil supplied to the front drive unit 12A may be insufficient. According to the above configuration, it is possible to suppress insufficient quantity of oil supplied to the front drive unit 12A.

### Second Embodiment

A second embodiment will be described. In the present embodiment, the processing content of S24 in FIG. 3 differs from the processing content of S24 in the first embodiment. Further, in the present embodiment, a wireless connection has already been established between the vehicle 2 and the information terminal 100 (see FIG. 1) owned by the occupant.

In S24, the control device 18 transmits predetermined notification information to the information terminal 100 by using a radio connection with the information terminal 100. Upon receiving the predetermined notification information transmitted from the vehicle 2, the information terminal 100 displays the predetermined notification information. The occupant can know the cause of the sound sensed by the user by confirming the notification information displayed on the information terminal 100. Therefore, it is possible to suppress the occupant feeling uncomfortable.

Although the specific examples disclosed by the present disclosure have been described in detail above, these are merely examples and do not limit the scope of claims. The techniques described in the claims include various modifications and alternations of the specific examples illustrated above.

(First modification) In S24 of FIG. 3, predetermined notification information may be outputted to both the user interface 20 of the vehicle 2 and the information terminal 100 owned by the occupant.

(Second modified example) the control device 18, when the user detects that the user has approached the vehicle 2, such as when the user holding the key of the vehicle 2 touches the door of the vehicle 2, may start the processing of FIG. 3. In another modification, the control device 18 may estimate the scheduled driving start time based on the past driving history of the user. Then, the control device 18 may start the processing of FIG. 3 when the time is a time before the scheduled operation start time or the scheduled operation start time by a predetermined time. In other words, when the user's intention to drive is detected, the control device 18 starts the process of FIG. 3.

S10, S20, S30, S40 of FIG. 3 (third modification) can be omitted. That is, the control device 18 may determine that the predetermined condition is satisfied when the vehicle 2 is switched from the ready-off state to the ready-on state, and may execute the preliminary lubricating process (S22) and the notification process (S24).

S20, S30 of FIG. 3 can be omitted (fourth modification). In the present modification, the control device 18 determines that the predetermined condition is satisfied when the vehicle 2 is switched from the ready-off state to the ready-on state and the stopping time exceeds the predetermined time (YES in S10), and executes the preliminary lubrication process (S22) and the notification process (S24).

(Fifth modification) The control device 18 may not be configured to be capable of executing the restricted travel mode. In this modification, S30 of FIG. 3 can be omitted. In the present modification, the control device 18 ends the process of FIG. 3 when it is determined that S20 is NO.

(Sixth modification) When determining NO in 20 of FIG. 3, the control device 18 may begin the charging process of charging the auxiliary battery 16 using the main battery 14. In the present modification, when the remaining amount of the auxiliary battery 16 exceeds the second predetermined value while the vehicle 2 is stopped, the control device 18 may shift from the limited traveling mode to the normal traveling mode and execute S22, S24 process.

(Seventh modification) The control device 18, prior to S10, may perform a S20. In the present modification, the control device 18 executes S10, S22, S24, S30, and S40 when determining that the remaining capacity of the auxiliary battery 16 exceeds the first predetermined value. On the other hand, when determining that the remaining amount of the auxiliary battery 16 does not exceed the first predetermined value, the control device 18 executes the charging process. When the remaining capacity of the auxiliary battery 16 exceeds the second predetermined value, the control device 18 executes S10, S22, S24, S30, S40 process.

(Eighth modification) In the respective embodiments, the front drive unit 12A and the rear drive unit 12B is an eAxle of a so-called one-axis type. In a modification, the front drive unit 12A and the rear drive unit 12B may be a three-axis eAxle or the like.

In addition, the technical elements described in this specification or in the drawings exhibit technical usefulness alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A vehicle comprising:
a drive unit in which a lubrication requiring element is accommodated in a case;
an electric oil pump that sucks oil in the case and supplies the oil to the lubrication requiring element; and
a control device that controls operation of the electric oil pump, wherein the control device is configured to execute
a preliminary lubrication process of operating the electric oil pump when a predetermined condition is satisfied in a state in which the vehicle is stopped, and
an informing process of outputting predetermined notification information to at least one of a user interface of the vehicle and an information terminal owned by an occupant when the preliminary lubrication process is executed.

2. The vehicle according to claim 1, wherein the control device is configured to suppress execution of the preliminary lubrication process until the state in which the vehicle is stopped stands for more than a predetermined time.

3. The vehicle according to claim 1, wherein the predetermined condition is satisfied when the vehicle is switched from ready-off to ready-on.

4. The vehicle according to claim 1, further comprising a battery that supplies electric power to the electric oil pump, wherein the control device is configured to suppress execution of the preliminary lubrication process when a remaining amount of the battery is equal to or less than a predetermined value.

5. The vehicle according to claim 4, wherein the control device is configured to limit an output of the drive unit when the execution of the preliminary lubrication process is suppressed on condition that the remaining amount of the battery is equal to or less than the predetermined value.
